(19) United States
(12) Patent Application Publication
(10) Pub. No.: US 2024/0185464 A1
(43) Pub. Date: Jun. 6, 2024

(54) INFORMATION PROCESSING DEVICE AND INFORMATION PROCESSING METHOD

(71) Applicant: SONY GROUP CORPORATION, TOKYO (JP)

(72) Inventor: KENICHIRO OI, TOKYO (JP)

(21) Appl. No.: 18/550,707

(22) PCT Filed: Feb. 3, 2022
(86) PCT No.: PCT/JP2022/004190

§ 371 Date: Sep. 15, 2023

(30) Foreign Application Priority Data
Mar. 24, 2021 (JP) 2021-050728

(51) Int. Cl. G06T 7/80; B64U 101/00; H04N 17/00

(52) U.S. Cl. CPC G06T 7/85; H04N 17/002; B64U 2101/00; B64U 2201/10; G06T 2207/10012; G06T 2207/10032; G06T 2207/30204; G06T 2207/30244

(57) ABSTRACT

An information processing device (100) according to an aspect of the present disclosure includes a control unit (150). A control unit (150) executes calibration processing of a plurality of cameras by using an image for calibration processing obtained by photographing a mobile body with the plurality of cameras while moving the mobile body whose movable range is not limited as a jig for calibration.

### FIELD

The present disclosure relates to an information processing device and an information processing method.

### BACKGROUND

Conventionally, as disclosed in Patent Literature 1, a technique of capturing a wide range with a camera and measuring a position of a robot has been proposed. On the other hand, in order to measure a position with a camera, calibration for obtaining a relative positional relationship between a coordinate system representing the camera and a coordinate system representing a position of a measurement target such as a robot is required.

Furthermore, in a case of measuring an object using a stereo camera, calibration for obtaining a relative positional relationship between cameras is required in addition to the above-described positional relationship. For example, Patent Literature 2 proposes a technique of setting a movement range of a target mark in a range of a visual field of a single visual sensor (For example, a camera) or a range of a visual field of each camera of a stereo camera in a space where the target mark moves in advance.

### CITATION LIST

### Patent Literature

Patent Literature 1: Japanese Patent No. 5192598

Patent Literature 2: Japanese Patent No. 6396516

### SUMMARY

### Technical Problem

However, the calibration work of the stereo camera has a problem that the wider the measurement range, the larger the work load on the operator. For example, in the calibration work of the stereo camera for measuring a wide area, the work of the operator at the installation site of the stereo camera is large, such as manually arranging a calibration jig or adjusting the orientation of the camera, and the work load increases.

Therefore, the present disclosure proposes an information processing device and an information processing method capable of reducing a work load when performing calibration work of a stereo camera.

### Solution to Problem

To solve the above problem, an information processing device that provides a service that requires an identity verification process according to an embodiment of the present disclosure includes: a control unit that executes calibration processing of a plurality of cameras by using an image for calibration processing obtained by photographing a mobile body whose movable range is not limited with the plurality of cameras while moving the mobile body as a calibration jig.

### BRIEF DESCRIPTION OF DRAWINGS

FIG. 1 is a diagram illustrating a relationship between a coordinate system and a matrix used in an embodiment of the present disclosure.

FIG. 2 is an explanatory diagram for explaining a specific coordinate system applied to a monitoring camera system according to the embodiment of the present disclosure.

FIG. 3 is a diagram illustrating a configuration example of the monitoring camera system according to the embodiment of the present disclosure.

FIG. 4 is a diagram illustrating an example of information processing of the monitoring camera system according to the embodiment of the present disclosure.

FIG. 5 is a diagram illustrating an example of a measurement range according to the embodiment of the present disclosure.

FIG. 6 is an explanatory diagram for explaining a visual field of a camera according to the embodiment of the present disclosure.

FIG. 7 is a view illustrating an example of a flight path of an unmanned aircraft according to the embodiment of the present disclosure.

FIG. 8 is a view illustrating another example of the flight path of the unmanned aircraft according to the embodiment of the present disclosure.

FIG. 9 is an explanatory diagram for explaining a marker arrangement plan according to the embodiment of the present disclosure.

FIG. 10 is an explanatory diagram for explaining a marker arrangement plan according to the embodiment of the present disclosure.

FIG. 11 is a view illustrating an example of a camera adjustment method according to the embodiment of the present disclosure.

FIG. 12 is a view illustrating another example of the camera adjustment method according to the embodiment of the present disclosure.

FIG. 13 is a view illustrating an acquired image of data for calibration processing according to the embodiment of the present disclosure.

FIG. 14 is an explanatory diagram for explaining the calibration processing according to the embodiment of the present disclosure.

FIG. 15 is a block diagram illustrating a configuration example of an information processing device according to the embodiment of the present disclosure.

FIG. 16 is a flowchart illustrating an example of a processing procedure of the information processing device according to the embodiment of the present disclosure.

FIG. 17 is a flowchart illustrating an example of a processing procedure of the information processing device according to the embodiment of the present disclosure.

FIG. 18 is a block diagram illustrating a hardware configuration example of a computer corresponding to the information processing device according to the embodiment of the present disclosure.

### DESCRIPTION OF EMBODIMENTS

Hereinafter, embodiments of the present disclosure will be described in detail with reference to the drawings. Note that, in the following embodiments, components having substantially the same functional configuration may be denoted by the same number or reference numeral, and redundant description may be omitted. In addition, in the present specification and the drawings, a plurality of components having substantially the same functional configuration may be distinguished and described by attaching different numbers or reference numerals after the same number or reference numeral.

In an embodiment of the present disclosure described below, calibration processing of a stereo camera constituting a monitoring camera system that measures a mobile body passing through an intersection will be described. Note that the embodiment of the present disclosure is applicable to calibration processing of a stereo camera in which the length, width, and height of the measurement range are several meters or more, and the parallax between the cameras is several meters or more, and is not particularly limited to the measurement range, the measurement target, and the like.

Furthermore, the description of the present disclosure will be made according to the following item order.
1. Embodiments
1-1. Regarding coordinate system
1-2. System configuration example
1-3. Overview of Information Processing
1-4. Configuration example of information processing device
1-5. Processing procedure example of information processing device
2. Others
3. Hardware Configuration Example
4. Conclusion

### 1. Embodiment

### <1-1. Regarding Coordinate System>

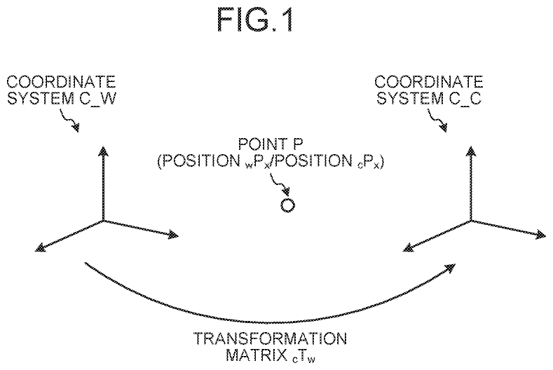

Hereinafter, a coordinate system used in an embodiment of the present disclosure will be described. FIG. 1 is a diagram illustrating a relationship between a coordinate system and a matrix used in an embodiment of the present disclosure. A coordinate system C_W illustrated in FIG. 1 represents a global coordinate system. Furthermore, a coordinate system C_C illustrated in FIG. 1 represents a local coordinate system. Further, the point P illustrated in FIG. 1 is an arbitrary point whose position in the space is defined by the coordinate system C_W or the coordinate system C_C, the position wPx represents the position of the point P in the coordinate system C_W, and the position cPx represents the position of the point P in the coordinate system C_C.

Furthermore, the matrix cTw illustrated in FIG. 1 represents a transformation matrix that transforms the position wPx of the point P in the coordinate system C_W into the position cPx in the coordinate system C_C. That is, the relationship between the position wPx of the point P in the coordinate system C_W and the position cPx of the point P in the coordinate system C_C can be expressed by the following Formula (1) using the matrix cTw.

cPx=cTw×wPx (1)

Furthermore, when a rotation matrix for converting the posture defined in the coordinate system C_W into the posture defined in the coordinate system C_C is represented as cRw, the matrix cTw is represented by a quadratic square matrix expressed by the following Formula (2).

$${}_{C} {T}_{W} = [ \begin{matrix}{}_{C} {R}_{W} & - {}_{C} {R}_{W} \cdot {}_{W} {P}_{C} \\ 0 & 1\end{matrix} ] \qquad ( 2 )$$

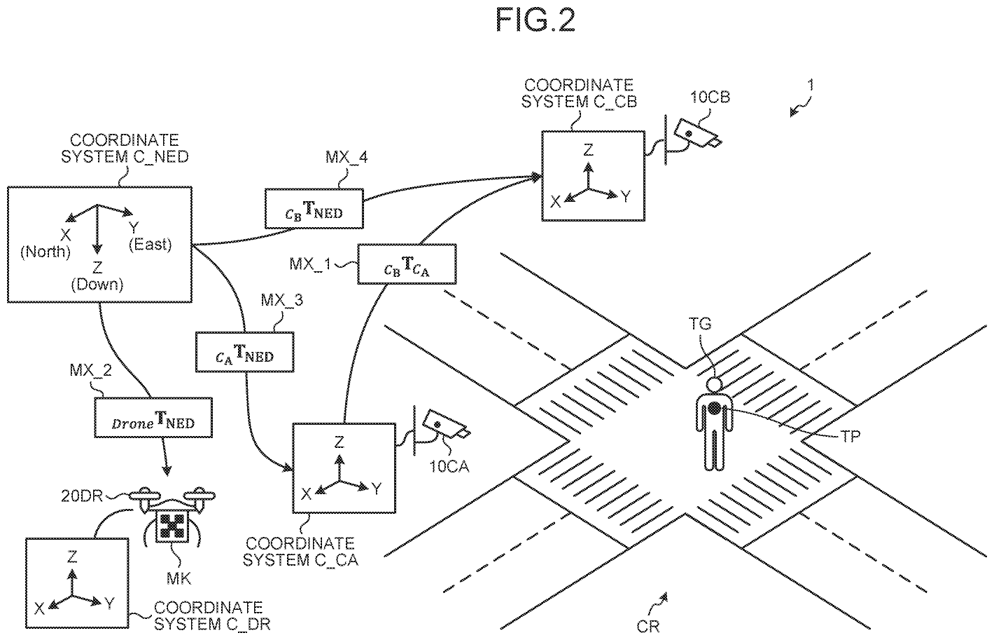

Next, a specific coordinate system applied to the monitoring camera system according to the embodiment of the present disclosure will be described. FIG. 2 is an explanatory diagram for explaining a specific coordinate system applied to a monitoring camera system according to the embodiment of the present disclosure. Note that FIG. 2 illustrates a schematic configuration of the monitoring camera system in order to describe a specific coordinate system applied to the monitoring camera system according to the embodiment of the present disclosure.

As illustrated in FIG. 2, a monitoring camera system 1 according to the embodiment of the present disclosure measures a predetermined area including an intersection CR using a plurality of cameras 10 such as a camera 10CA and a camera 10CB. Then, the monitoring camera system 1 measures the position of the measurement target such as a position TP of a pedestrian TG illustrated in FIG. 2 with the mobile body such as the pedestrian TG illustrated in FIG. 2 passing through an intersection CR as the measurement target.

In addition, in measuring a predetermined area including the intersection CR, the monitoring camera system 1 illustrated in FIG. 2 uses an unmanned aircraft 20DR as a jig for calibration to execute calibration processing of a plurality of cameras such as the camera 10CA (an example of a first camera) and the camera 10CB (an example of a second camera). The calibration processing generates calibration data (transformation matrix) that is a parameter for mutually transforming the position of the measurement target among the coordinate systems illustrated in FIG. 2. In the monitoring camera system 1, four coordinate systems C and four transformation matrices MX illustrated in FIG. 2 are used.

A coordinate system C_NED (an example of a position control coordinate system) illustrated in FIG. 2 is a local horizontal coordinate system for controlling the position of the unmanned aircraft 20DR measured using a global positioning system (GPS) using a relative positional relationship among an X axis, a Y axis, and a Z axis orthogonal to each other, with a predetermined reference position defined by the monitoring camera system 1 as an origin, a direction (latitude) of north (N) with respect to the reference position as an X axis, a direction (longitude) of east (E) as a Y axis, and a direction (altitude) of lower (D) as a Z axis. The coordinate system C_NED is a global coordinate system corresponding to the coordinate system C_W illustrated in FIG. 1. As the above-described reference position, for example, a position specified by latitude, longitude, and altitude acquired at the time of system activation can be used. Note that, in the monitoring camera system 1 illustrated in FIG. 2, a local horizontal coordinate system in which the downward direction is positive is adopted as an appropriate coordinate system in a case where a plurality of cameras are installed in a direction in which the measurement range is viewed from above, but any appropriate coordinate system can be adopted according to the measurement direction.

In addition, a coordinate system C_CA (an example of a first camera coordinate system) illustrated in FIG. 2 is a coordinate system for designating the position of the measurement target viewed from the camera 10CA by a relative positional relationship among an X axis, a Y axis, and a Z axis orthogonal to each other with the position of the camera 10CA as a reference (origin).

Furthermore, a coordinate system C_CB (an example of a second camera coordinate system) illustrated in FIG. 2 is a coordinate system for designating the position of the measurement target viewed from the camera 10CB by a relative positional relationship among an X axis, a Y axis, and a Z axis orthogonal to each other with the position of the camera 10CB as a reference (origin).

In addition, a coordinate system C_DR (an example of a mobile body coordinate system) illustrated in FIG. 2 is, for example, a coordinate system for designating the position of the measurement target viewed from the unmanned aircraft 20DR by a relative positional relationship among an X axis, a Y axis, and a Z axis orthogonal to each other with an arbitrary position of an airframe of the unmanned aircraft 20DR as a reference (origin). Note that the unmanned aircraft 20DR is equipped with a marker MK for calibration (an example of a “marker for image recognition”). The coordinate system C_CA, the coordinate system C_CB, and the coordinate system C_DR illustrated in FIG. 2 are local coordinate systems corresponding to the coordinate system C_C illustrated in FIG. 1.

Furthermore, a transformation matrix MX_1 illustrated in FIG. 2 is a transformation matrix (parameter) for transforming a position in the coordinate system C_CA into a position in the coordinate system C_CB. Furthermore, a transformation matrix MX_2 illustrated in FIG. 2 is a transformation matrix (parameter) for transforming a position in the coordinate system C_NED into a position in the coordinate system C_DR. Furthermore, a transformation matrix MX_3 illustrated in FIG. 2 is a transformation matrix (parameter) for transforming a position in the coordinate system C_NED into a position in the coordinate system C_CA. Furthermore, a transformation matrix MX_4 illustrated in FIG. 2 is a transformation matrix (parameter) for transforming a position in the coordinate system C_NED into a position in the coordinate system C_CB.

### <1-2. System Configuration Example>

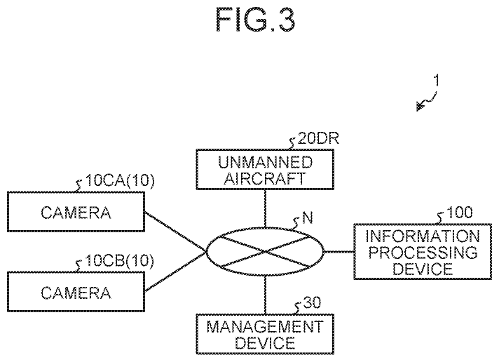

A configuration of the monitoring camera system 1 according to the embodiment of the present disclosure will be described with reference to FIG. 3. FIG. 3 is a diagram illustrating a configuration example of the monitoring camera system according to the embodiment of the present disclosure. Note that FIG. 3 illustrates an example of the configuration of the monitoring camera system 1, and is not limited to the example illustrated in FIG. 3. For example, the monitoring camera system 1 may include more cameras and management devices than the example illustrated in FIG. 3.

As illustrated in FIG. 3, the monitoring camera system 1 includes the camera 10CA, the camera 10CB, the unmanned aircraft 20DR, a management device 30, and an information processing device 100. The camera 10CA, the camera 10CB, the unmanned aircraft 20DR, the management device 30, and the information processing device 100 are connected to a network N in a wired or wireless manner. The camera 10CA and the camera 10CB can communicate with the information processing device 100 through the network N. The unmanned aircraft 20DR can communicate with the information processing device 100 through the network N. The management device 30 can communicate with the information processing device 100 through the network N. The information processing device 100 can communicate with the camera 10CA and the camera 10CB, the unmanned aircraft 20DR, and the management device 30 through the network N.

The camera 10CA and the camera 10CB are stereo cameras, and acquire (capture) an image of a measurement range at a predetermined frame rate. The images acquired by the camera 10CA and the camera 10CB may be arbitrary images such as a visible light image and an infrared image. The camera 10CA and the camera 10CB are installed in advance at positions capable of photographing the unmanned aircraft 20DR moving in the measurement range. The camera 10CA and the camera 10CB include a communication unit for communicating with the information processing device 100. The camera 10CA and the camera 10CB transmit the acquired images to the information processing device 100.

The unmanned aircraft 20DR performs autonomous flight according to a flight path for calibration processing defined in a flight plan received from the information processing device 100. In addition, the unmanned aircraft 20DR is mounted in a state where a marker MK (see FIG. 2) for calibration processing can be photographed by the camera 10CA or the camera 10CB.

Furthermore, the unmanned aircraft 20DR includes, for example, various sensors that detect information around the unmanned aircraft, a posture of the unmanned aircraft, and the like, a camera that photographs surroundings of the unmanned aircraft, a communication unit that communicates with other devices, a flight device that causes the unmanned aircraft to fly, a controller that executes autonomous flight control, and the like. For example, the controller generates a control signal for causing the unmanned aircraft to autonomously fly according to the flight path on the basis of an analysis result obtained by analyzing information from various sensors and cameras, and inputs the control signal to the flight device. In addition, when controlling the flight of the unmanned aircraft 20DR according to the flight path, the controller can control the flight of the unmanned aircraft 20DR so as to fly while avoiding obstacles on the flight path according to an analysis result obtained by analyzing information from various sensors and cameras.

In addition, the unmanned aircraft 20DR is equipped with a global positioning system (GPS) unit, an inertial measurement unit (IMU), and the like as various sensors. In addition, the unmanned aircraft 20DR acquires position information from a GPS unit or the like each time the unmanned aircraft stops at the arrangement position of the marker MK indicated in the flight path. After the end of the flight according to the flight path, the unmanned aircraft 20DR transmits the acquired position information to the information processing device 100. The unmanned aircraft 20DR can be implemented by, for example, a drone (multicopter), a model aircraft capable of autonomous flight, or the like.

The management device 30 manages various types of information regarding the calibration processing. The various types of information regarding the calibration processing include, for example, information such as a surrounding map of the measurement range, a flight plan of the unmanned aircraft, and required accuracy of calibration. The management device 30 includes a communication unit for communicating with other devices, a storage device that stores various types of information, a control device that executes various types of processing of the management device 30, and the like.

In addition, the management device 30 provides information such as a flight plan for the calibration processing and required accuracy of the calibration processing in response to a request from the information processing device 100. In addition, the management device 30 records a report indicating the result of the calibration processing received from the information processing device 100. The management device 30 can be implemented by, for example, a cloud system in which server devices and storage devices connected to a network operate in cooperation with each other. Note that the management device 30 may be implemented by a single server device.

As described below, the information processing device 100 is an information processing device that comprehensively controls calibration processing in the monitoring camera system 1. The information processing device 100 can be implemented by a personal computer, a tablet, or the like.

### <1-3. Overview of Information Processing>

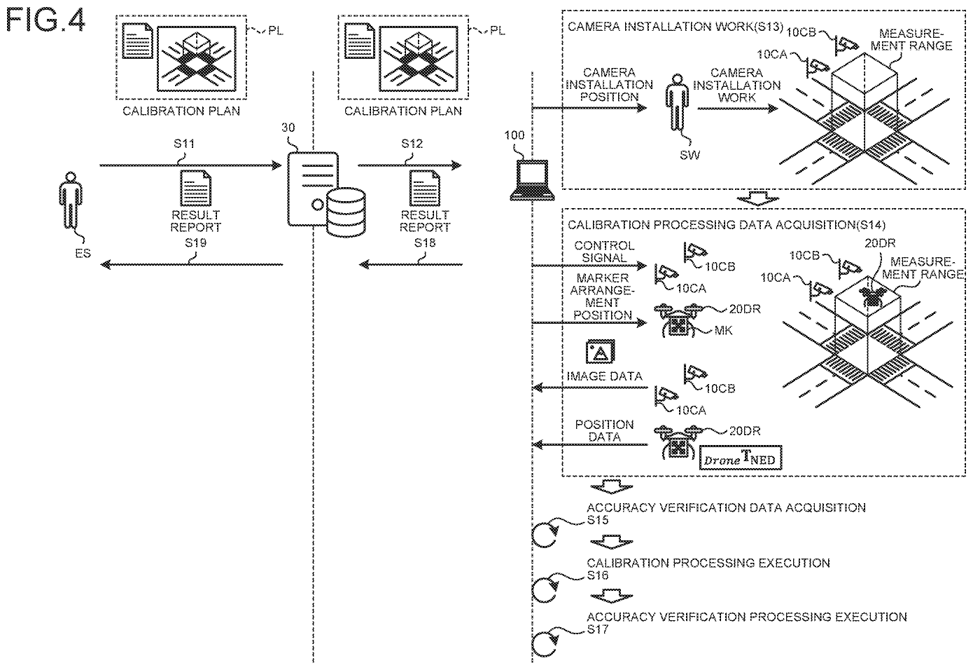

Hereinafter, an outline of information processing in the monitoring camera system 1 according to the embodiment of the present disclosure will be described. FIG. 4 is a diagram illustrating an example of information processing of the monitoring camera system according to the embodiment of the present disclosure. Note that, in the following description, an example in which two stereo cameras cover a measurement range targeted by the monitoring camera system 1 will be described.

As illustrated in FIG. 4, a technical director ES who supervises the calibration processing of the monitoring camera system 1 creates a calibration plan as preliminary preparation for the calibration processing, and registers the created calibration plan in the management device 30 (Step S11). Hereinafter, an example of preliminary preparation for the calibration processing will be sequentially described.

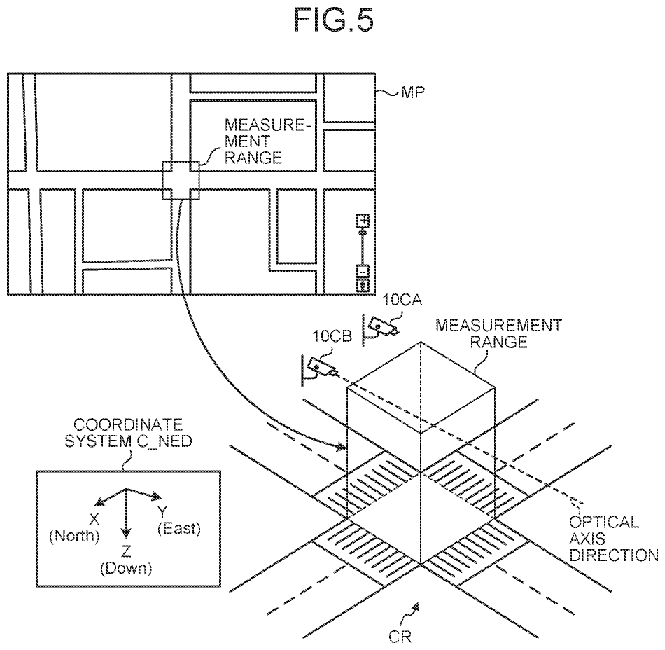

Specifically, the technical director ES defines the measurement range for measuring the position of the subject to be position-measured from the map using the camera 10CA and the camera 10CB. The camera 10CA and the camera 10CB desirably have the same performance. FIG. 5 is a diagram illustrating an example of a measurement range according to the embodiment of the present disclosure.

The technical director ES displays a setting window (not illustrated) for calibration processing on a terminal device (not illustrated) operated by the technical director ES. In addition, the technical director ES reads map information installed in advance in the terminal device and displays a map MP on the setting window, and designates a measurement range in the vicinity of the intersection CR on the map MP, for example, as illustrated in FIG. 5. The measurement range is designated on the basis of empirical rules of the technical director ES. In order to easily define the flight path of the unmanned aircraft 20DR, the measurement range is desirably a prismatic space whose bottom surface and top surface are polygonal. In the example illustrated in FIG. 5, the measurement range is defined as a quadrangular prism space. When the measurement range is constituted by a prismatic space, the position of each vertex of the measurement range can be designated in the coordinate system C_NED.

In addition, the technical director ES determines the installation position of each camera 10 and the optical axis direction of each camera 10 from the measurement range. The technical director ES designates the installation position of each camera 10 by the coordinate system C_NED. Specifically, the technical director ES performs a simulation using computer graphics (CG) or computer-aided design (CAD) on the terminal device operated by the technical director ES on the basis of the angle of view, the optical axis direction, and the like of each camera 10, and determines whether the installation position of each camera 10 covers the measurement range. As a result of the simulation, when the installation position of each camera 10 does not cover the measurement range, the technical director ES considers changing the installation position of each camera 10, adding the number of cameras 10, and the like.

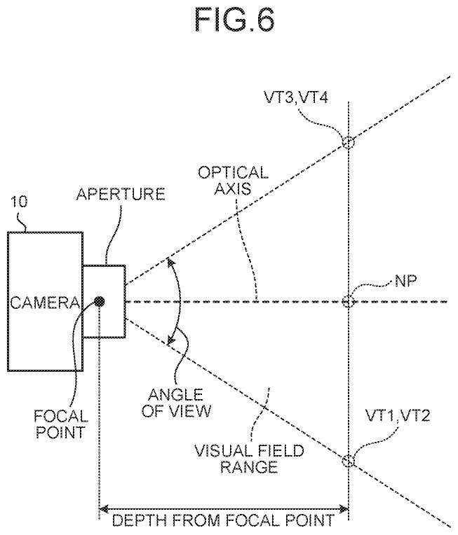

After determining the installation position and the optical axis direction of each camera 10, the technical director ES calculates coordinates of four corners (four vertices) of the visual field (photographable range) of each camera 10 in the coordinate system C_NED on the basis of the angle of view of the camera 10 and the distance to the subject. The coordinates of the four corners are used as marks at the time of flight of the unmanned aircraft 20DR when the camera is installed on the site. That is, as described later, a site worker SW can adjust the angle of view of each camera 10 while checking the flight trajectory of the unmanned aircraft 20DR with the camera 10 even in the air where a physical mark cannot be installed. FIG. 6 is an explanatory diagram for explaining a visual field of the camera according to the embodiment of the present disclosure. FIG. 6 is a plan view of the camera 10 as viewed from directly above. Note that, in FIG. 6, only one camera 10 is illustrated for convenience of description.

As illustrated in FIG. 6, the technical director ES sets the depth (distance) from the focal point of the camera 10 to the nearest point NP closest to the center of the measurement range among points on the optical axis of the camera 10 as the distance to the subject. Note that how to determine the distance to the subject does not need to be particularly limited as long as the subject in the measurement range can be photographed. Then, the technical director ES obtains coordinates of four vertices VT1 to VT4 corresponding to the four corners of the visual field (photographable range) of the camera 10 on the basis of the depth from the focal point of the camera 10 to the nearest point NP and the angle of view of the camera 10.

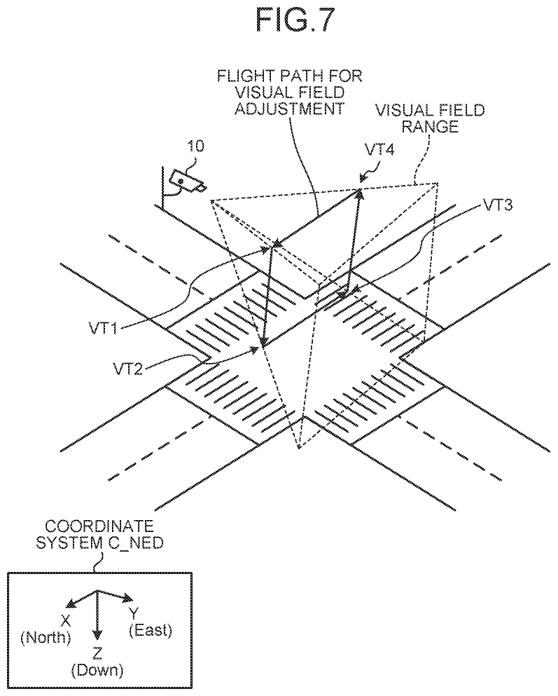

After calculating the coordinates of the four corners (four vertices) of the visual field (photographable range) of each camera 10, the technical director ES determines a flight path for visual field adjustment using the unmanned aircraft 20DR. FIG. 7 is a view illustrating an example of a flight path of the unmanned aircraft according to the embodiment of the present disclosure. Note that, in FIG. 7, only one camera 10 is illustrated for convenience of description.

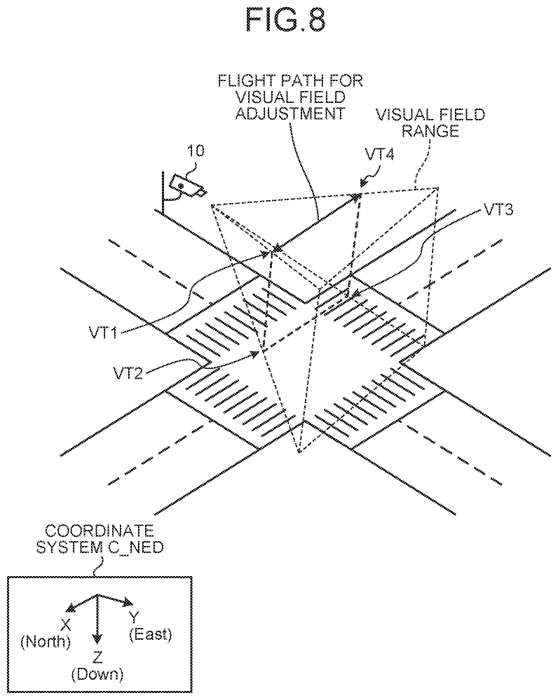

As illustrated in FIG. 7, the technical director ES plans a flight path for circling along each side of a quadrangle connecting four vertices VT1 to VT4 corresponding to four corners of the visual field (photographable range). In the example illustrated in FIG. 7, a flight path which circles along each side connecting four vertices corresponding to four corners of the visual field counterclockwise around the vertices VT1, VT2, VT3, and VT4 is illustrated. Note that, in a case where it is difficult to determine the flight path illustrated in FIG. 7 due to environmental conditions at the site such as presence of an obstacle, the technical director ES can determine another flight path for visual field adjustment. FIG. 8 is a diagram illustrating another example of the flight path of the unmanned aircraft according to the embodiment of the present disclosure.

As illustrated in FIG. 8, the technical director ES may plan a flight path for reciprocating flight on a line connecting the vertex VT1 and the vertex VT4 of the quadrangle among the four corners of the visual field (photographable range). Note that the invention is not limited to the example illustrated in FIG. 8, and the technical director ES can arbitrarily plan, according to the environmental conditions, for example, a flight path that reciprocates on a line connecting the vertex VT1 and the vertex VT3 of the quadrangle, a flight path that reciprocates on a line connecting the vertex VT2 and the vertex VT4 of the quadrangle, a flight path that reciprocates between the vertex VT1 and the vertex VT3 on a line connecting the vertex VT1 and the vertex VT2 and on a line connecting the vertex VT2 and the vertex VT3 of the quadrangle, and the like.

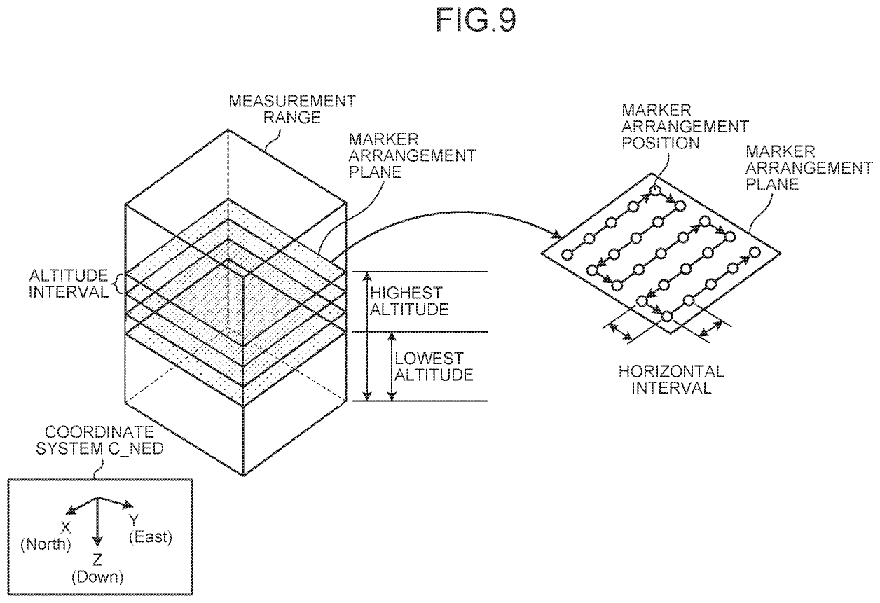

After determining the flight path for visual field adjustment, the technical director ES plans the arrangement position of the marker MK (see FIG. 2) for calibration processing. FIG. 9 is an explanatory diagram for explaining a marker arrangement plan according to the embodiment of the present disclosure.

As illustrated in FIG. 9, the technical director ES designates the highest altitude and the lowest altitude of the virtual marker arrangement plane on which the marker MK for calibration processing is arranged in the measurement range. In addition, the technical director ES designates the altitude interval between the marker arrangement planes and the horizontal interval for arranging the marker MK on the marker arrangement plane on the basis of the required accuracy of the calibration processing. The horizontal intervals in the vertical direction or the lateral direction of the marker arrangement plane may be equal or unequal. In addition, the horizontal interval in the vertical direction and the horizontal interval in the lateral direction of the marker arrangement plane may be the same interval, or may be different intervals. The marker arrangement positions are automatically designated on the marker arrangement plane by the horizontal interval designated by the technical director ES. The marker arrangement position is a measurement point of data for calibration processing (image data of the marker MK and position data of the marker MK (unmanned aircraft 20DR)). As the marker arrangement position, a position (latitude, longitude, and altitude) designated by the coordinate system C_NED is used. Note that the technical director ES may designate the flight path for the calibration processing so as to pass all the marker arrangement positions (measurement points) with respect to the marker arrangement plane.

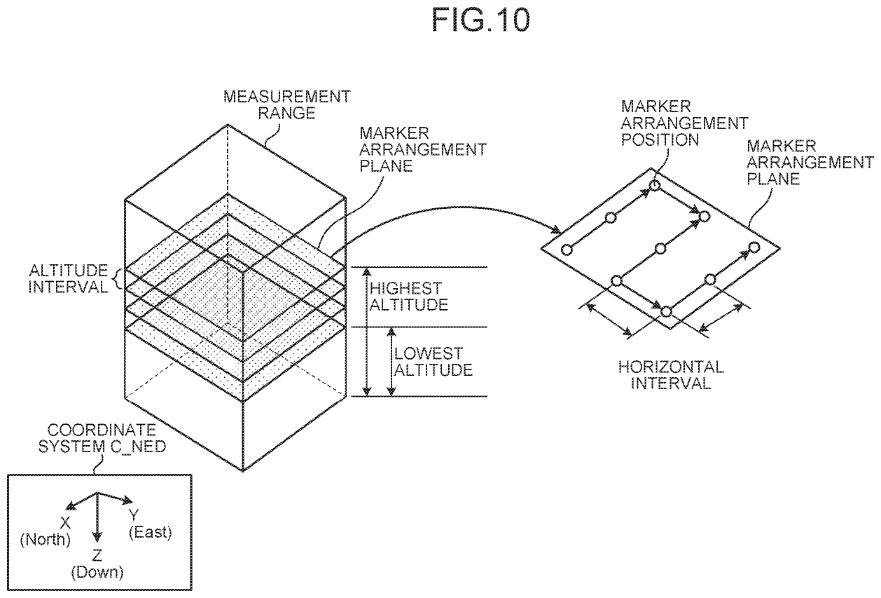

In addition, the technical director ES plans the arrangement position of the marker MK for accuracy verification of the calibration processing. FIG. 10 is an explanatory diagram for explaining a marker arrangement plan according to the embodiment of the present disclosure.

The plan for designating the arrangement position of the marker MK for accuracy verification of the calibration processing is executed in a procedure basically similar to the plan (FIG. 9) for designating the arrangement position of the marker MK for calibration processing described above. Note that the arrangement position of the marker MK for accuracy verification of the calibration processing is desirably planned at a position that does not overlap with the arrangement position of the marker MK for the calibration processing in order to accurately evaluate the accuracy of the calibration processing. That is, it is desirable to designate the marker arrangement position so that the marker arrangement position illustrated in FIG. 10 does not overlap the marker arrangement position illustrated in FIG. 9. Note that, when the arrangement position of the marker MK for accuracy verification of the calibration processing is planned, the altitude interval between the marker arrangement planes may be designated to an interval different from the calibration processing.

When the arrangement plan of the markers MK for accuracy verification is completed, the technical director ES operates the terminal device to create a calibration plan including a measurement range, an installation position and an optical axis direction of each camera 10, a flight path for visual field adjustment, an arrangement position of the marker MK (see FIG. 2) for calibration processing, an arrangement position of the marker MK for accuracy verification of the calibration processing, and the like, and registers the calibration plan in the management device 30.

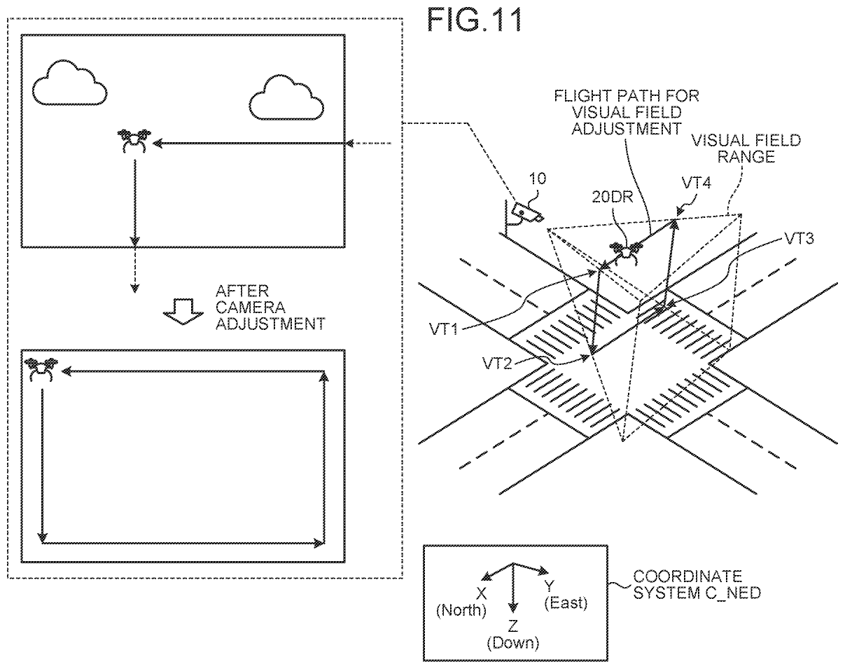

Returning to FIG. 4, the management device 30 transmits the calibration plan to the information processing device 100 in response to a request from the information processing device 100 (Step S12). The site worker SW operating the information processing device 100 performs installation work of each camera 10 on the basis of the calibration plan acquired from the management device 30 (Step S13). The installation work of each camera 10 will be described below. FIG. 11 is a diagram illustrating an example of a camera adjustment method according to the embodiment of the present disclosure. Note that, in FIG. 11, only one camera 10 is illustrated for convenience of description.

The site worker SW installs each camera 10 on the basis of the installation position and the optical axis direction of each camera 10 included in the calibration plan. Subsequently, the site worker SW operates the information processing device 100 to register the flight path included in the calibration plan in the unmanned aircraft 20DR. Then, the site worker SW causes the unmanned aircraft 20DR to autonomously fly and adjusts the angle of view of the camera 10.

For example, it is assumed that a flight path for visual field adjustment (see FIG. 7) is planned by the technical director ES so as to circle along four corners of the visual field (photographable range). In this case, as illustrated in FIG. 11, the unmanned aircraft 20DR circles counterclockwise on the flight path for visual field adjustment registered by the site worker SW. The site worker SW outputs the image captured by the camera 10 to a monitor or the like to check the image, and adjusts the angle of view of the camera 10. Specifically, as illustrated in FIG. 11, the site worker SW adjusts the position, angle, and the like of the camera 10 so that the state (flight trajectory) of the unmanned aircraft 20DR circling on the flight path for visual field adjustment falls within the visual field of the camera 10 as closely as possible.

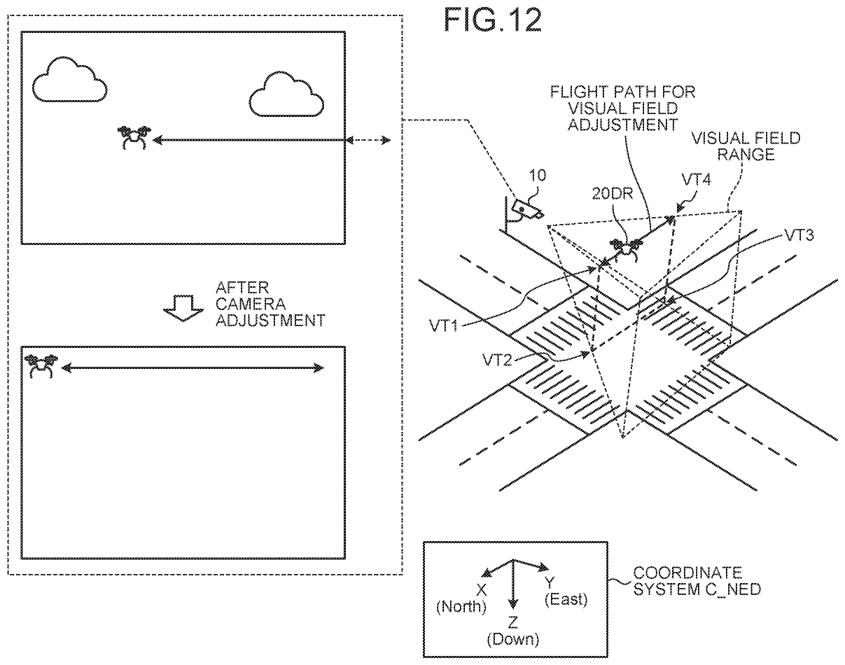

In addition, the adjustment of the angle of view in a case where a flight path (see FIG. 8) in which the aircraft reciprocates on one side of the visual field (photographable range) is planned by the technical director ES will be described. FIG. 12 is a diagram illustrating another example of the camera adjustment method according to the embodiment of the present disclosure. In this case, as illustrated in FIG. 12, the unmanned aircraft 20DR reciprocates on the flight path registered by the site worker SW. As in the example illustrated in FIG. 11, the site worker SW outputs an image captured by the camera 10 to a monitor or the like to check the image, and adjusts the angle of view of the camera 10. Specifically, as illustrated in FIG. 12, the site worker SW adjusts the position, angle, and the like of the camera 10 so that the state (flight trajectory) of the unmanned aircraft 20DR reciprocating on the flight path for visual field adjustment falls within the visual field of the camera 10 as closely as possible.

Returning to FIG. 4, when the installation work of the camera 10 is completed, the site worker SW acquires data for calibration processing (Step S14). Specifically, the site worker SW recovers the unmanned aircraft 20DR and attaches the marker MK to the unmanned aircraft 20DR. In the example illustrated in FIG. 4, a planar marker having a checker pattern is attached to the unmanned aircraft 20DR as the marker MK, but the present invention is not limited to this example, and an infrared light emitting marker, an infrared reflecting bead marker, or the like may be used.

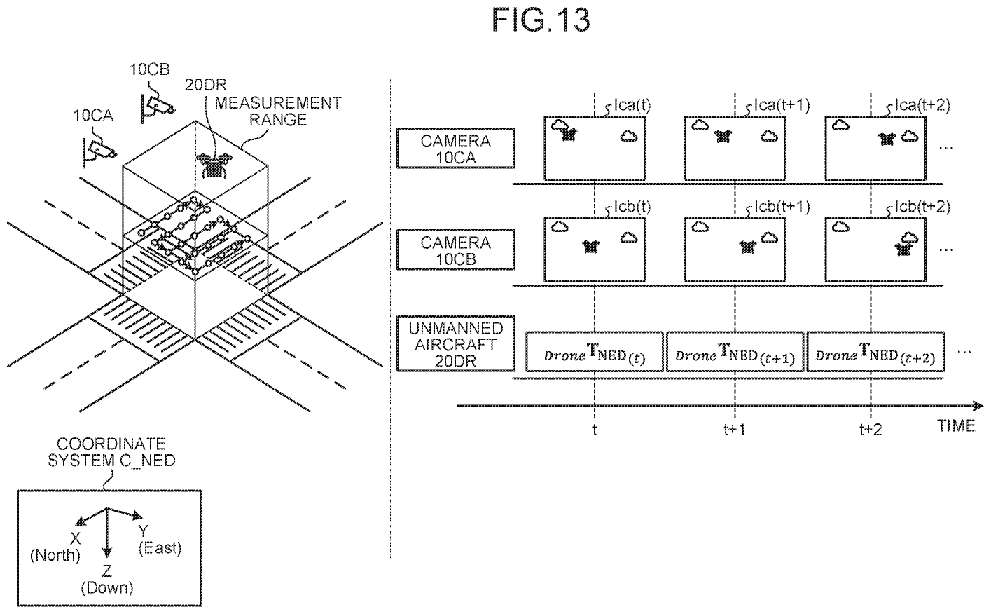

After attaching the marker MK, the site worker SW acquires the arrangement position of the marker MK for calibration processing included in the calibration plan, and registers the acquired marker arrangement position in the unmanned aircraft 20DR. Then, the site worker SW causes the unmanned aircraft 20DR to autonomously fly and starts acquisition of data for calibration processing. FIG. 13 is a diagram illustrating an acquired image of data for calibration processing according to the embodiment of the present disclosure. The left diagram of FIG. 13 is an image diagram schematically illustrating a state at the time of acquiring data for calibration processing, and the right diagram of FIG. 13 is a diagram schematically illustrating a relationship between data acquired by each camera 10 and the unmanned aircraft 20DR.

Each time the unmanned aircraft 20DR reaches the marker arrangement position, the information processing device 100 sequentially transmits a photographing control signal to the camera 10CA and the camera 10CB so as to synchronously acquire the image of the marker MK (unmanned aircraft 20DR) (see FIG. 4). The camera 10CA and the camera 10CB acquire (capture) the image of the marker MK according to the photographing control signal received from the information processing device 100, and record the acquired image.

In addition, the unmanned aircraft 20DR plans a flight path passing through all the marker arrangement positions on the basis of the marker arrangement positions registered by the site worker SW, and autonomously flies along the planned flight path. During autonomous flight, each time the unmanned aircraft 20DR reaches the marker arrangement position, the unmanned aircraft stops at the marker arrangement position for a preset time to secure a photographing time of the camera 10CA and the camera 10CB. Further, each time the unmanned aircraft 20DR stops at the marker arrangement position, the unmanned aircraft acquires position data (“_{Drone}T_{NED}”) indicating the position of the unmanned aircraft measured by the GPS unit, for example, and records the acquired position data. When the unmanned aircraft 20DR navigates while constantly estimating the position and the posture of the airframe using detection data of a GPS unit, an IMU, or the like, the unmanned aircraft generates a transformation matrix (_{Drone}T_{NED}) using the position (_{NED}P_{Drone}) and the posture (_{NED}R_{Drone}) of the airframe obtained as an estimation result, and records the transformation matrix as position data.

For example, as illustrated in FIG. 13, the image data acquired by each camera 10 and the position data acquired by the unmanned aircraft 20DR are synchronized with each other according to the time at which the data for the calibration processing is measured. For example, the image data and the position data can be synchronized with each other on the basis of the GPS time when the information processing device 100 transmits the photographing control signal to each camera 10 and the GPS time that can be acquired by the unmanned aircraft 20DR. The information processing device 100 may include a GPS unit or may be connected to a server device or the like capable of acquiring a GPS time. In the example illustrated in FIG. 13, at time (t), image data lca(t) acquired by the camera 10CA, image data lcb(t) acquired by the camera 10CB, and position data (_{Drone}T_{NED(t)}) acquired by the unmanned aircraft 20DR are synchronized with each other. The position data (_{Drone}T_{NED(t)}) acquired by the unmanned aircraft 20DR corresponds to a transformation matrix _{Drone}T_{NED(t)} for transforming the position of the unmanned aircraft 20DR in the coordinate system C_NED into the position in the coordinate system C_DR when the image data lca(t) and the image data lcb(t) are acquired. In the calibration processing according to the embodiment of the present disclosure, the position data (_{Drone}T_{NED(t)}) is handled as the position of the unmanned aircraft 20DR.

Returning to FIG. 4, when the unmanned aircraft 20DR completes the planned flight for the calibration processing, the information processing device 100 collects the data for the calibration processing. For example, the camera 10CA and the camera 10CB transmit image data to the information processing device 100 in response to a request from the information processing device 100. In addition, for example, the unmanned aircraft 20DR transmits position data corresponding to image data to the information processing device 100 in response to a request from the information processing device 100.

Subsequently, the site worker SW acquires data for accuracy verification of the calibration processing (Step S15). The procedure of acquiring the data for accuracy verification of the calibration processing is similar to the procedure of acquiring the data for calibration processing described above except that the marker arrangement positions registered in the unmanned aircraft 20DR are different.

Specifically, the site worker SW recovers the unmanned aircraft 20DR, acquires the arrangement position of the marker MK for calibration processing included in the calibration plan, and registers the acquired marker arrangement position in the unmanned aircraft 20DR. Then, the site worker SW causes the unmanned aircraft 20DR to autonomously fly and starts acquisition of data for accuracy verification of the calibration processing.

Each time the unmanned aircraft 20DR reaches the marker arrangement position, the information processing device 100 sequentially transmits the photographing control Signal to the camera 10CA and the camera 10CB so as to synchronously acquire the image of the marker MK. The camera 10CA and the camera 10CB acquire (capture) the image of the marker MK according to the photographing control signal received from the information processing device 100, and record the acquired image.

In addition, the unmanned aircraft 20DR autonomously flies so as to sew the marker arrangement position with one stroke on the basis of the marker arrangement position for accuracy verification of the calibration processing registered by the site worker SW. During autonomous flight, each time the unmanned aircraft 20DR reaches the marker arrangement position, the unmanned aircraft stops at the marker arrangement position for a preset time to secure a photographing time of the camera 10CA and the camera 10CB. In addition, each time the unmanned aircraft 20DR stops at the marker arrangement position, the unmanned aircraft acquires position information indicating the position of the unmanned aircraft measured by, for example, a GPS unit, and records the acquired position information.

When the acquisition of the data for accuracy verification of the calibration processing is completed, the camera 10CA and the camera 10CB transmit image data to the information processing device 100. Further, the unmanned aircraft 20DR transmits position data corresponding to the image data to the information processing device 100.

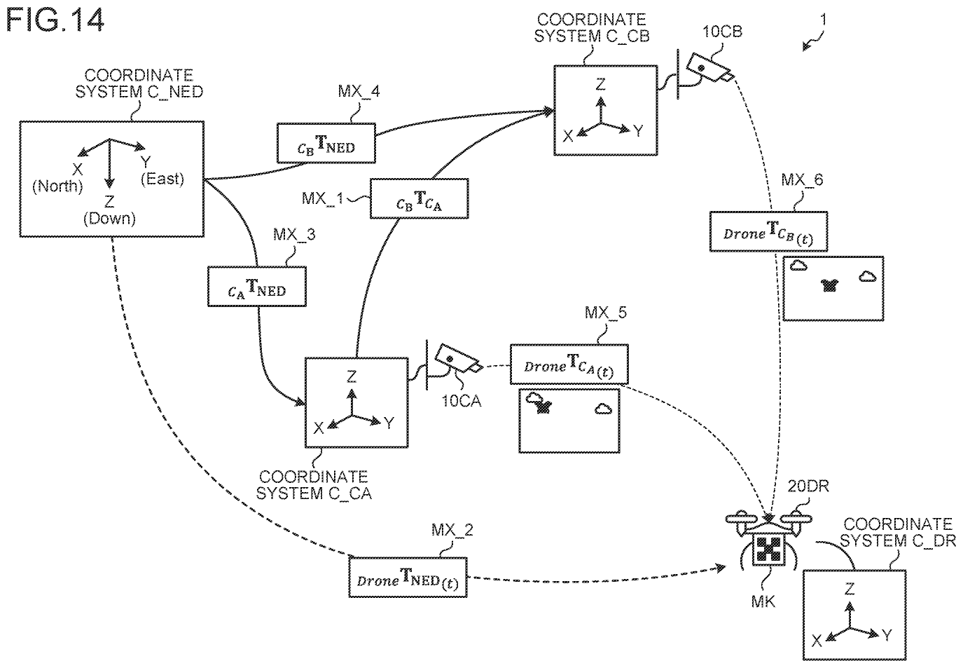

When the acquisition of the data for calibration processing and the data for accuracy verification of the calibration processing is completed, the information processing device 100 first executes the calibration processing using the data for calibration processing (Step S16). FIG. 14 is an explanatory diagram for explaining the calibration processing according to the embodiment of the present disclosure.

As illustrated in FIG. 14, the information processing device 100 calibrates (calculates) the transformation matrix MX_1 (“_{CB}T_{CA}”), the transformation matrix MX_3 (“_{CA}T_{NED}”), and the transformation matrix MX_4 (“_{CB}T_{NED}”) by using the image data and the position data acquired as the data for the calibration processing.

First, the information processing device 100 calculates the transformation matrix MX_1 (“_{CB}T_{CA}”). Specifically, image data acquired by the camera 10CA and the camera 10CB is read, image recognition processing is executed, and the marker MK in each image is detected. The information processing device 100 specifies the position of the unmanned aircraft 20DR on the image acquired by the camera 10CA and the position of the unmanned aircraft 20DR on the image acquired by the camera 10CB on the basis of the detected position of the marker MK, and calculates the transformation matrix MX_1 (“_{CB}T_{CA}”) for transforming the position in the coordinate system C_CA into the position in the coordinate system C_CB on the basis of each specified position. As a calibration method, any method as shown in the following reference can be used.

(Reference) “Flexible Camera Calibration By Viewing a Plane From Unknown Orientations”, Zhengyou Zhang, Proceedings of the Seventh IEEE International Conference on Computer Vision (1999).

Furthermore, the information processing device 100 calibrates (calculates) the transformation matrix MX_3 (“_{CA}T_{NED}”) and the transformation matrix MX_4 (“_{CB}T_{NED}”) by using the following Formulas (3) and (4). In the following Formulas (3) and (4), “I₄” represents an identity matrix. Furthermore, in the following Formulas (3) and (4), ∥A∥(A is the difference between the product of the transformation matrix and the identity matrix) represents the L2 norm (spectrum norm) of the matrix. Since it is premised that the positions of the camera 10CA and the camera 10CB do not move in the coordinate system C_NED, the Formula (3) for obtaining the transformation matrix MX_3 (“_{CA}T_{NED}”) for transforming the position in the coordinate system C_NED into the position in the coordinate system C_CA and the Formula (4) for obtaining the transformation matrix MX_4 (“_{CB}T_{NED}”) for transforming the position in the coordinate system C_NED into the position in the coordinate system C_CB are given as optimization problems for confirming whether the displacement amount is the transformation matrix _{NED}T_{NED} of “0 (0)” as described below.

$${min}_{{c}_{A}^{{T}_{NED}}} {\sum }_{t = 1}^{N} \{ {‖}_{Drone} {T}_{{NED}_{( t )}}^{T} \times {}_{Drone} {T}_{{C}_{{A}_{( t )}}} {\times }_{{C}_{A}} {T}_{NED} - {I}_{4} ‖ + ‖ {}_{Drone} {T}_{{NED}_{( t )}}^{T} \times {}_{Drone} {T}_{{C}_{{B}_{( t )}}} \times {}_{{c}_{B}} {T}_{{C}_{A}} \times {}_{{C}_{A}} {T}_{NED} - {I}_{4} ‖ \} \qquad ( 3 )$$

$${min}_{{c}_{B}^{{T}_{NED}}} {\sum }_{t = 1}^{N} \{ ‖ {}_{Drone} {T}_{{NED}_{( t )}}^{T} \times {}_{Drone} {T}_{{C}_{{B}_{( t )}}} {\times }_{{C}_{B}} {T}_{NED} - {I}_{4} ‖ + ‖ {}_{Drone} {T}_{{NED}_{( t )}}^{T} \times {}_{Drone} {T}_{{C}_{{A}_{( t )}}} {\times }_{{C}_{B}} {T}_{{C}_{A}}^{T} \times {}_{{C}_{B}} {T}_{NED} - {I}_{4} ‖ \} \qquad ( 4 )$$

Specifically, as illustrated in FIG. 14, the information processing device 100 calculates the transformation matrix MX_2 (“_{Drone}T_{NED(t)}”) for transforming the position in the coordinate system C_NED into the position in the coordinate system C_DR on the basis of the position data recorded in the unmanned aircraft 20DR and the position in the coordinate system C_NED set as the arrangement position of the marker MK at each time(t) when the data for the calibration processing is acquired.

Furthermore, the information processing device 100 calculates a transformation matrix MX_5 (“_{Drone}T_{CA(t)}”), which is a parameter for transforming the position in the coordinate system C_CA into the position in the coordinate system C_DR, from the position of the marker MK in the image data captured by the camera 10CA at each time(t) when the data for the calibration processing is acquired.

Furthermore, the information processing device 100 calculates a transformation matrix MX_6 (“_{Drone}T_{CB(t)}”), which is a parameter for transforming the position in the coordinate system C_CB into the position in the coordinate system C_DR, from the position of the marker MK in the image data captured by the camera 10CB at each time (t) when the data for the calibration processing is acquired.

Then, the information processing device 100 uses the transformation matrix MX_1 (“_{CB}T_{CA}”) calculated for each time(t), the transformation matrix MX_2 (“_{Drone}T_{NED(t)}”), the transformation matrix MX_5 (“_{Drone}T_{CA(t)}”), and the transformation matrix MX_6 (“_{Drone}T_{CB(t)}”) to solve the optimization problems expressed by Formulas (3) and (4) described above, thereby calculating the transformation matrix MX_3 (“_{CA}T_{NED}”) for transforming the position in the coordinate system C_NED into the position in the coordinate system C_CA and the transformation matrix MX_4 (“_{CB}T_{NED}”) for transforming the position in the coordinate system C_NED into the position in the coordinate system C_CB.

Returning to FIG. 4, when the calibration processing is completed, the information processing device 100 executes accuracy verification processing of verifying the accuracy of the calibration processing (Step SS17). Specifically, the information processing device 100 specifies the position of the unmanned aircraft 20DR on the image acquired by the camera 10CA and the position of the unmanned aircraft 20DR on the image acquired by the camera 10CB on the basis of the position of the marker MK, and calculates an evaluation value indicating the accuracy of the calibration processing using the transformation matrix MX_1 (“_{CB}T_{CA}”) on the basis of each specified position. Note that, as a method of calculating the evaluation value, any method such as the method described in the reference can be used.

Furthermore, the information processing device 100 calculates the error values of Formulas (3) and (4) described above and the error values of Formulas (5) and (6) described below for each image frame as evaluation values indicating the accuracy of the calibration processing of the transformation matrix MX_3 (“_{CA}T_{NED}”) and the transformation matrix MX_4 (“_{CB}T_{NED}”). Note that an image frame for which the accuracy of the calibration processing is less than the required accuracy is specified from the image data for the calibration processing by the error values for each image frame in the following Formulas (5) and (6).

$${\sum }_{t = 1}^{N} \{ ‖ {}_{Drone} {T}_{{NED}_{t}}^{T} \times {}_{Drone} {T}_{{C}_{{A}_{( t )}}} {\times }_{{C}_{A}} {T}_{NED} - {I}_{4} ‖ + \qquad ( 5 )$$

$$‖ {}_{Drone} {T}_{{NED}_{( t )}}^{T} \times {}_{Drone} {T}_{{C}_{{B}_{( t )}}} \times {}_{{C}_{B}} {T}_{{C}_{A}} \times {}_{{C}_{A}} {T}_{NED} - {I}_{4} ‖ \}$$

$${\sum }_{t = 1}^{N} \{ ‖ {}_{Drone} {T}_{{NED}_{( t )}}^{T} \times {}_{Drone} {T}_{{C}_{{B}_{( t )}}} \times {}_{{C}_{B}} {T}_{NED} - {I}_{4} ‖ + \qquad ( 6 )$$

$$‖ {}_{Drone} {T}_{{NED}_{( t )}}^{T} \times {}_{Drone} {T}_{{C}_{{A}_{( t )}}} \times {}_{{C}_{B}} {T}_{{C}_{A}}^{T} \times {}_{{C}_{B}} {T}_{NED} - {I}_{4} ‖ \}$$

Returning to FIG. 4, when the accuracy verification processing ends, the information processing device 100 generates a result report indicating the accuracy verification result of the calibration processing and transmits the generated report to the management device 30 (Step S18).

In response to a request from the technical director ES, the management device 30 provides a result report indicating the accuracy verification result of the calibration processing (Step S19).

The technical director ES causes the terminal device operated by the technical director to display the result report acquired from the management device 30, and checks the evaluation value indicating the accuracy of the calibration processing. When the technical director ES determines that the accuracy of the calibration processing is less than the required accuracy, the technical director creates an additional calibration plan for acquiring data of the calibration processing again. For example, as an additional calibration plan, for example, a plan of intensively capturing an image around a position indicated by position data associated with an image frame determined to have a large error is conceivable. When creating an additional calibration plan, the technical director ES instructs the site worker SW to register the additional calibration plan in the management device 30 and execute the calibration processing and the like again.

### <1-4. Configuration Example of Information Processing Device>

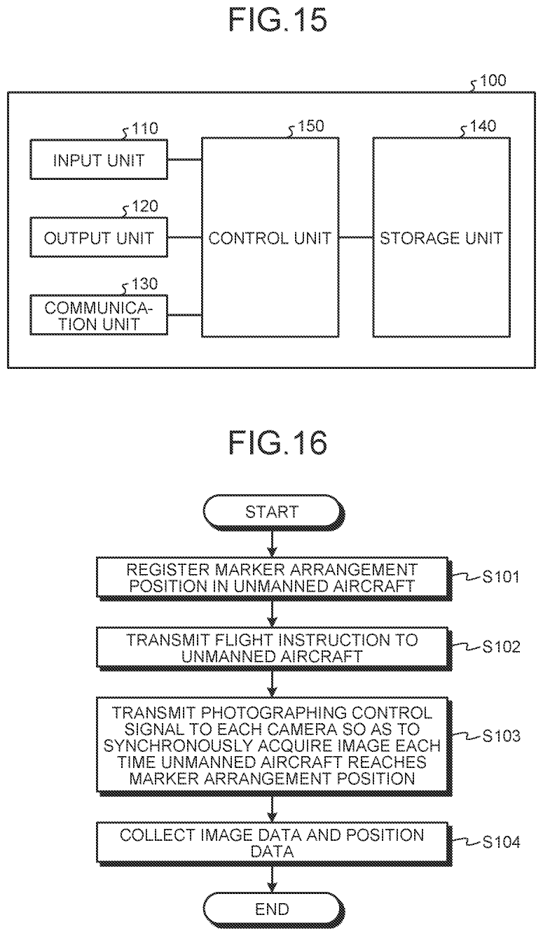

A configuration example of the information processing device 100 according to the embodiment of the present disclosure will be described with reference to FIG. 15. FIG. 15 is a block diagram illustrating a configuration example of an information processing device according to an embodiment of the present disclosure. As illustrated in FIG. 15, the information processing device 100 includes an input unit 110, an output unit 120, a communication unit 130, a storage unit 140, and a control unit 150.

Note that FIG. 15 illustrates an example of the configuration of the information processing device 100, and is not limited to the example illustrated in FIG. 15, and other configurations may be used.

The input unit 110 receives various operations. The input unit 110 is implemented by an input device such as a mouse, a keyboard, or a touch panel. For example, the input unit 110 receives inputs of various operations related to calibration processing of each camera 10 from the site worker SW.

The output unit 120 outputs various types of information. The output unit 120 is implemented by an output device such as a display or a speaker.

The communication unit 130 transmits and receives various types of information. The communication unit 130 is implemented by a communication module for transmitting and receiving data to and from another device in a wired or wireless manner. The communication unit 130 communicates with another device by a method such as wired local area network (LAN), wireless LAN, Wi-Fi (Wireless Fidelity, registered trademark), infrared communication, Bluetooth (registered trademark), near field communication, or non-contact communication.

For example, the communication unit 130 receives information on the calibration plan from the management device 30. Furthermore, for example, the communication unit 130 transmits a photographing control signal to each camera 10. Furthermore, for example, the communication unit 130 transmits information on the marker arrangement position to the unmanned aircraft 20DR. Furthermore, for example, the communication unit 130 receives image data for calibration processing from each camera 10. Furthermore, for example, the communication unit 130 receives position data for calibration processing from the unmanned aircraft 20DR. Furthermore, for example, the communication unit 130 transmits a result report indicating the result of the accuracy verification processing of the calibration processing to the management device 30.

The storage unit 140 is implemented by, for example, a semiconductor memory element such as a random access memory (RAM) or a flash memory, or a storage device such as a hard disk or an optical disk. The storage unit 140 can store, for example, programs, data, and the like for implementing various processing functions executed by the control unit 150. The programs stored in the storage unit 140 include an operating system (OS) and various application programs.

The control unit 150 is implemented by a control circuit including a processor and a memory. The various processing executed by the control unit 150 are implemented, for example, by executing a command described in a program read from an internal memory by a processor using the internal memory as a work area. The programs read from the internal memory by the processor include an operating system (OS) and an application program. Furthermore, the control unit 150 may be implemented by, for example, an integrated circuit such as an application specific integrated circuit (ASIC) or a field-programmable gate array (FPGA).

Furthermore, the main storage device and the auxiliary storage device functioning as the internal memory described above are implemented by, for example, a semiconductor memory element such as a random access memory (RAM) or a flash memory, or a storage device such as a hard disk or an optical disk.

While moving the unmanned aircraft 20DR (an example of a “mobile body”) whose movable range is not limited as a calibration jig, the control unit 150 executes the calibration processing of the camera 10CA and the camera 10CB by using the image for the calibration processing obtained by photographing unmanned aircraft 20DR with the camera 10CA and the camera 10CB.

In addition, on the basis of the position of the unmanned aircraft 20DR (marker MK) in the image captured by the camera 10CA and the position of the unmanned aircraft 20DR (marker MK) in the image captured by the camera 10CB, the control unit 150 executes calibration to obtain a parameter for transforming the position of the unmanned aircraft 20DR in the coordinate system C_CA (an example of the “first camera coordinate system”) corresponding to the camera 10CA into the position of the unmanned aircraft 20DR in the camera coordinate system C_CB (an example of the “second camera coordinate system”) corresponding to the camera 10CB. That is, the control unit 150 executes calibration for obtaining the transformation matrix MX_1 (“_{CB}T_{CA}”) described above.

In addition, the control unit 150 executes calibration for obtaining a parameter for transforming the position in the coordinate system C_CA into a position in the coordinate system C_NED (an example of a “position control coordinate system”) for controlling the position of the unmanned aircraft 20DR in the measurement range and a parameter for transforming the position in the coordinate system C_CB into a position in the coordinate system C_NED on the basis of the parameter for transforming the position in the coordinate system C_CA into the position in the coordinate system C_DR (an example of a “mobile body coordinate system”) based on the position of the unmanned aircraft 20DR and the parameter for transforming the position in the coordinate system C_CB into the position in the coordinate system C_DR.

In addition, in a case where the marker MK is mounted on the unmanned aircraft 20DR, the control unit 150 registers, in the unmanned aircraft 20DR, an arrangement position of the marker MK planned in advance for photographing the image used for the calibration processing when photographing the image used for the calibration processing.

Furthermore, the control unit 150 executes accuracy verification processing for verifying the accuracy of the calibration processing. In addition, when photographing an image used for the accuracy verification processing, the control unit 150 registers, in the unmanned aircraft 20DR, an arrangement position of an image recognition marker planned in advance for photographing an image used for the accuracy verification processing.

In addition, the control unit 150 uploads a report indicating the result of the accuracy verification processing to the management device 30 (an example of an “external device”) through the communication unit 130.

### <1-5. Processing Procedure Example of Information Processing Device>

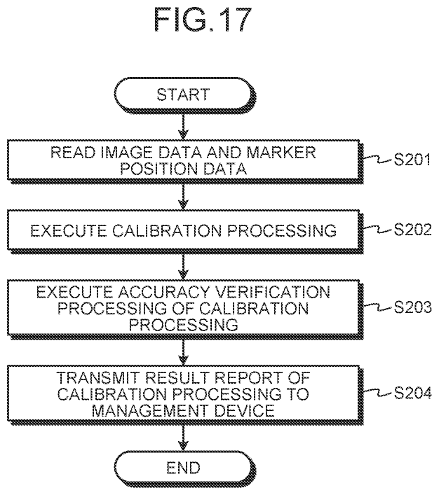

An example of a processing procedure of the information processing device 100 according to the embodiment of the present disclosure will be described with reference to FIGS. 16 and 17. FIGS. 16 and 17 are flowcharts illustrating an example of a processing procedure of the information processing device according to the embodiment of the present disclosure. The processing procedure illustrated in FIGS. 16 and 17 is executed by the control unit 150. The processing procedure illustrated in FIGS. 16 and 17 is started in response to an operation by the site worker SW, for example.

First, data acquisition processing executed by the information processing device 100 will be described with reference to FIG. 16. As illustrated in FIG. 16, the control unit 150 registers information on the marker arrangement position for calibration processing in the unmanned aircraft 20DR (Step S101). After registering the information on the marker arrangement position, the control unit 150 transmits a flight instruction to the unmanned aircraft 20DR (Step S102).

In addition, each time the unmanned aircraft 20DR reaches the marker arrangement position, the control unit 150 sequentially transmits the photographing control signal to the camera 10CA and the camera 10CB so as to synchronously acquire the image of the marker MK (unmanned aircraft 20DR) (Step S103).

In addition, when the unmanned aircraft 20DR finishes the planned flight for the calibration processing, the control unit 150 collects the image data recorded by each camera 10 and the position data recorded in the unmanned aircraft 20DR (Step S104), and ends the processing procedure illustrated in FIG. 16.

Next, a series of flow of the calibration processing and the accuracy verification processing of the calibration processing by the information processing device 100 will be described with reference to FIG. 17. As illustrated in FIG. 17, the control unit 150 reads image data and position data collected as data for calibration processing (Step S201).

In addition, the control unit 150 executes the above-described calibration processing using the read image data and position data (Step S202). When the calibration processing is completed, the control unit 150 executes the above-described accuracy verification processing (Step S203).

When the accuracy verification processing is completed, the control unit 150 creates a result report indicating the verification result of the accuracy of the calibration processing, transmits the created result report to the management device 30 (Step S204), and ends the processing procedure illustrated in FIG. 17.

### 2. Others

### <2-1. Method for Displaying Result Report>

In the above-described embodiment, information other than the information indicating the verification result of the accuracy of the calibration processing may be included in the result report. For example, in a case where the unmanned aircraft 20DR detects an obstacle during a flight for acquiring data for calibration processing, and changes a planned flight path or stops the flight, position data at the time of performing the action is recorded as obstacle information. The information processing device 100 includes the obstacle information received from the unmanned aircraft 20DR in the result report and registers the result report in the management device 30. The terminal device used by the technical director ES is configured to display the result report in a state in which the obstacle information is reflected on the map when displaying the result report. As a result, the technical director ES can refer to the obstacle information included in the result report and use the obstacle information at the time of creating the subsequent calibration plan.

Furthermore, in a case where there is an image frame in which the position of the marker MK cannot be detected from the image of each camera 10, the information processing device 100 may include position data synchronized with the corresponding image frame in the result report. When displaying the result report, the terminal device used by the technical director ES is configured to display a portion where the marker MK cannot be detected in a state of being reflected on the map.

### <2-2. Posture Control of Marker>

In a case where a planar marker is used as the marker MK for calibration processing, as the angle formed between the plane including the surface of the marker having a recognition pattern such as a checker pattern and the optical axis of the camera 10 becomes closer to a right angle, that is, as the lens of the camera 10 and the surface of the marker become closer to parallel, the detection accuracy of the marker MK in the image processing is improved. Therefore, the unmanned aircraft 20DR may control the posture of the marker MK so that the surface of the marker having the recognition pattern faces the lens of the camera 10 as much as possible during the flight for acquiring the data for the calibration processing. For example, a robot arm for adjusting the posture of the marker MK is mounted on the unmanned aircraft 20DR. Then, the unmanned aircraft 20DR can continuously adjust the posture of the marker MK by calculating the appropriate posture of the marker MK using the transformation matrix MX_2 (_{Drone}T_{NED}) for transforming the position in the coordinate system C_NED for controlling the position of the unmanned aircraft 20DR into the position in the coordinate system C_DR with the position of the unmanned aircraft 20DR as the origin and driving the robot arm on the basis of the calculation result.

### <2-3. Calibration Plan>

In the above-described embodiment, the technical director ES may incorporate the relationship between the depth from the focal point where the camera 10 can recognize the marker MK and the measurement range by the camera 10 into the calibration plan. As a result, it is possible to formulate a calibration plan in consideration of the success rate of the detection of the marker MK.

### <2-4. System Configuration>

In the above-described embodiment, an example in which the monitoring camera system 1 is configured to include the unmanned aircraft 20DR equipped with the marker MK has been described, but the present invention is not particularly limited to this example. For example, the monitoring camera system 1 may be configured to include a robot that autonomously travels on the ground and a marker MK attached to a robot arm included in the robot. Furthermore, in the above-described embodiment, the monitoring camera system 1 has been described in which the measurement range is set at the intersection and a mobile body such as a pedestrian or a vehicle passing through the intersection is a measurement target. However, the measurement range is not particularly limited to the intersection, and the measurement range may be set in a shopping mall, an amusement park, or the like. In addition, the measurement target is not limited to a mobile body to be monitored such as a pedestrian or a vehicle, and for example, the unmanned aircraft 20DR can be used as the measurement target.

### <2-5. Utilization Example of Calibration Processing Result>

In the above-described embodiment, the recognition result of each camera 10 can be mapped to one coordinate system C_NED by using the transformation matrix obtained by the calibration processing. Therefore, a utilization example of the calibration processing result obtained by the above-described embodiment will be described.

For example, in the case of human detection, when the position of the person in each camera 10 can be detected, the position of the person in each camera 10 can be transformed into the position in the coordinate system C_NED using the transformation matrix MX_3 (“_{CA}T_{NED}”, see FIG. 2) and the transformation matrix MX_4 (“_{CB}T_{NED}”, see FIG. 2) obtained by the above-described calibration processing. Consequently, the detection result of the person in each camera 10 can be managed in one coordinate system (For example, the coordinate system C_NED), and the detection result of the person can efficiently be used. For example, use for tracking a criminal at a crime scene can be considered.

Furthermore, it is also conceivable to use the position of the target point in each camera 10 for controlling the position of the unmanned aircraft 20DR. For example, in a situation where the number of captured GPS satellites is small and the accuracy of the position information obtained from the GPS unit mounted on the unmanned aircraft 20DR is assumed, the position of the target point in each camera 10 may be used. Specifically, by using the transformation matrix MX_3 (“_{CA}T_{NED}”) and the transformation matrix MX_5 (“_{Drone}T_{CA}”), the unmanned aircraft 20DR transforms the position of the target point in the coordinate system C_NED into the coordinate system C_CA, transforms the position of the target point in the coordinate system C_CA into the coordinate system C_DR, and controls the flight on the basis of the transformed position of the target point in the coordinate system C_DR. As a result, the flight of the unmanned aircraft 20DR can be controlled with high accuracy.

Furthermore, various programs for implementing the information processing method executed by the information processing device 100 according to the embodiment of the present disclosure described above may be stored and distributed in a computer-readable recording medium or the like such as an optical disk, a semiconductor memory, a magnetic tape, or a flexible disk. At this time, the information processing device 100 according to the embodiment of the present disclosure can implement the information processing method according to the embodiment of the present disclosure by installing and executing various programs on a computer.

In addition, various programs for implementing the information processing method executed by the information processing device 100 according to the embodiment of the present disclosure described above may be stored in a disk device included in a server on a network such as the Internet and may be downloaded to a computer. Furthermore, functions provided by various programs for implementing the information processing method executed by the information processing device 100 according to the embodiment of the present disclosure may be implementing by cooperation of the OS and the application program. In this case, a portion other than the OS may be stored in a medium and distributed, or a portion other than the OS may be stored in an application server and downloaded to a computer.

Furthermore, at least a part of the processing function for implementing the information processing method executed by the information processing device 100 according to the embodiment of the present disclosure described above may be implemented by a cloud server on a network. For example, at least a part of the calibration processing and the accuracy verification processing of the calibration processing according to the above-described embodiment may be executed on a cloud server.

Among the processing described in the embodiment of the present disclosure described above, all or a part of the processing described as being performed automatically can be performed manually, or all or a part of the processing described as being performed manually can be performed automatically by a known method. In addition, the processing procedure, specific name, and information including various types of data and parameters illustrated in the document and the drawings can be arbitrarily changed unless otherwise specified. For example, the various types of information illustrated in each figure are not limited to the illustrated information.

Furthermore, each component of the information processing device 100 according to the embodiment of the present disclosure described above is functionally conceptual, and is not necessarily required to be configured as illustrated in the drawings. For example, the control unit 150 included in the information processing device 100 may be physically or functionally distributed to the function of controlling each camera 10 and the function of controlling the unmanned aircraft 20DR.

In addition, the embodiment and the modification of the present disclosure can be appropriately combined within a range not contradicting processing contents. Furthermore, the order of each step illustrated in the flowchart according to the embodiment of the present disclosure can be changed as appropriate.

Although the embodiments and modifications of the present disclosure have been described above, the technical scope of the present disclosure is not limited to the above-described embodiments and modifications, and various modifications can be made in a range not departing from the gist of the present disclosure. In addition, components of different embodiments and modifications may be appropriately combined.

### 3. Hardware Configuration Example

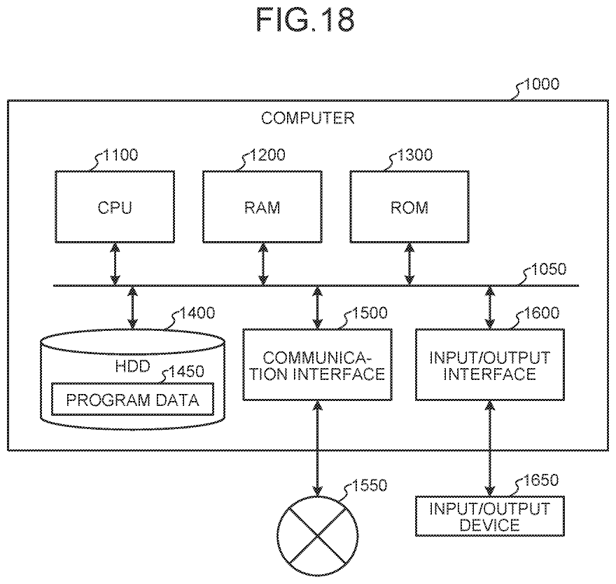

A hardware configuration example of a computer corresponding to the information processing device 100 according to the embodiment of the present disclosure described above will be described with reference to FIG. 18. FIG. 18 is a block diagram illustrating a hardware configuration example of a computer corresponding to the information processing device according to the embodiment of the present disclosure. Note that FIG. 18 illustrates an example of a hardware configuration of a computer corresponding to the information processing device 100, and the configuration is not necessarily limited to the configuration illustrated in FIG. 18.

As illustrated in FIG. 18, a computer 1000 corresponding to the information processing device 20 according to each embodiment and modification of the present disclosure includes a central processing unit (CPU) 1100, a random access memory (RAM) 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 develops a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-transiently records a program executed by the CPU 1100, data used by the program, and the like. Specifically, the HDD 1400 records the program data 1450. The program data 1450 is an example of an information processing program for implementing the information processing method according to the embodiment and data used by the information processing program.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input/output interface 1600 is an interface for connecting the input/output device 1650 and the computer 1000. For example, the CPU 1100 receives data from an input device such as a keyboard and a mouse via the input/output interface 1600. In addition, the CPU 1100 transmits data to an output device such as a display device, a speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the information processing device 100 according to the embodiment, the CPU 1100 of the computer 1000 executes the information processing program loaded on the RAM 1200 to implement various processing functions executed by the control unit 150 illustrated in FIG. 15.

That is, the CPU 1100, the RAM 1200, and the like implement information processing by the information processing device 100 according to the embodiment of the present disclosure in cooperation with software (information processing program loaded on the RAM 1200).

### 4. Conclusion

An information processing device 100 according to an embodiment of the present disclosure includes a control unit 150 that executes calibration processing of a plurality of cameras by using an image for calibration processing obtained by photographing a mobile body (for example, an unmanned aircraft 20DR) having an unlimited movable range by the plurality of cameras while moving the mobile body as a calibration jig. As a result, the information processing device 100 can automate at least a part of the calibration work such as installation of the jig and acquisition of the calibration image even in the measurement range in which the artificial calibration work is difficult, and can reduce the work load when performing the calibration work of the stereo camera.

In addition, the control unit 150 executes calibration for obtaining a parameter for transforming a position in a first camera coordinate system (for example, the coordinate system C_CA) based on a position of a first camera (for example, the camera 10CA) into a position in a second camera coordinate system (for example, the coordinate system C_CB) based on a position of a second camera (for example, the camera 10CB) on the basis of a position of the mobile body in a first image captured by the first camera and a position of the mobile body in a second image captured by the second camera. As a result, the information processing device 100 can easily acquire the relative positional relationship of the positions in the camera coordinate system (local coordinate system) corresponding to each camera that executes measurement of the measurement range for which artificial calibration work is difficult.

Furthermore, the control unit 150 executes calibration for obtaining a parameter for transforming the position in the first camera coordinate system into a position in a position control coordinate system (for example, the coordinate system C_NED) for controlling the position of the mobile body in the measurement range and a parameter for transforming the position in the second camera coordinate system into a position in the position control coordinate system, on the basis of the parameter for transforming the position in the first camera coordinate system into the position in the mobile body coordinate system (for example, the coordinate system C_DR) based on the position of the mobile body and the parameter for transforming the position in the second camera coordinate system into the position in the mobile body coordinate system. As a result, a relative positional relationship between the camera coordinate system (local coordinate system) corresponding to each camera that executes measurement of the measurement range for which artificial calibration work is difficult and the position in the position control coordinate system (global coordinate system) for controlling the position of the mobile body in the measurement range can be easily acquired.

In addition, the control unit 150 registers, in the mobile body, information indicating the position of the measurement point planned in advance for acquiring data used for the calibration processing. As a result, it is possible to prevent artificial data variation due to manual arrangement of jigs when acquiring data for calibration processing.

Furthermore, the control unit 150 executes accuracy verification processing for verifying the accuracy of the calibration processing. Thus, the content of the calibration processing can be evaluated.

In addition, the control unit 150 registers, in the mobile body, information indicating the position of the measurement point planned in advance for acquiring data used for the accuracy verification processing. As a result, it is possible to prevent artificial data variation due to manual arrangement of jigs when acquiring data for accuracy verification processing of the calibration processing.

In addition, the control unit 150 uploads a report indicating the result of the accuracy verification processing to the external device. As a result, the result of the calibration processing can be easily checked from a place other than the site where the calibration is performed.

The mobile body is an unmanned aircraft. As a result, even in a measurement range (site) where it is difficult to manually arrange the jig for calibration processing, the jig can be easily arranged.

The position control coordinate system is a local horizontal coordinate system. As a result, the position of the mobile body can be appropriately designated.

Note that the effects described in the present specification are merely illustrative or exemplary and are not restrictive. That is, the technology of the present disclosure can exhibit other effects obvious to those skilled in the art from the description of the present specification together with or instead of the above effects.

Note that the technology of the present disclosure can also have the following configurations as belonging to the technical scope of the present disclosure.

(1)

An information processing device comprising a control unit that executes calibration processing of a plurality of cameras by using an image for calibration processing obtained by photographing a mobile body whose movable range is not limited with the plurality of cameras while moving the mobile body as a calibration jig.

(2)

The information processing device according to (1), wherein the control unit
executes calibration for obtaining a parameter for converting a position in a first camera coordinate system based on a position of a first camera into a position in a second camera coordinate system based on a position of a second camera on a basis of a position of the mobile body in a first image captured by the first camera and a position of the mobile body in a second image captured by the second camera.
   (3)

The information processing device according to (2), wherein the control unit
executes calibration for obtaining a parameter for converting a position in the first camera coordinate system into a position in a position control coordinate system for controlling a position of the mobile body in a measurement range and a parameter for converting a position in the second camera coordinate system into a position in the position control coordinate system on a basis of a parameter for converting a position in the first camera coordinate system into a position in a mobile body coordinate system based on a position of the mobile body and a parameter for converting a position in the second camera coordinate system into a position in the mobile body coordinate system.
   (4)

The information processing device according to any one of (1) and (3), wherein the control unit
registers, in the mobile body, information indicating a position of a measurement point planned in advance for acquiring data used for the calibration processing.
   (5)

The information processing device according to (2), wherein the control unit
executes accuracy verification processing of verifying accuracy of the calibration processing.
   (6)

The information processing device according to (5), wherein the control unit
registers, in the mobile body, information indicating a position of a measurement point planned in advance for acquiring data used for the accuracy verification processing.
   (7)

The information processing device according to (6), wherein the control unit
uploads a report indicating a result of the accuracy verification processing to an external device.
   (8)

The information processing device according to any one of (1) and (7), wherein the mobile body is an unmanned aircraft.

(9)

The information processing device according to (3), wherein the position control coordinate system is a local horizontal coordinate system.

(10)

An information processing method comprising executing calibration processing of a plurality of cameras by using an image for calibration processing obtained by photographing a mobile body whose movable range is not limited with the plurality of cameras while moving the mobile body as a jig for the calibration processing.

### REFERENCE SIGNS LIST

1 MONITORING CAMERA SYSTEM
10 CAMERA
20DR UNMANNED AIRCRAFT
30 MANAGEMENT DEVICE
100 INFORMATION PROCESSING DEVICE
110 INPUT UNIT
120 OUTPUT UNIT
130 COMMUNICATION UNIT
140 STORAGE UNIT
150 CONTROL UNIT

1. An information processing device comprising a control unit that executes calibration processing of a plurality of cameras by using an image for calibration processing obtained by photographing a mobile body whose movable range is not limited with the plurality of cameras while moving the mobile body as a calibration jig.

2. The information processing device according to claim 1, wherein the control unit
executes calibration for obtaining a parameter for converting a position in a first camera coordinate system based on a position of a first camera into a position in a second camera coordinate system based on a position of a second camera on a basis of a position of the mobile body in a first image captured by the first camera and a position of the mobile body in a second image captured by the second camera.

3. The information processing device according to claim 2, wherein the control unit
executes calibration for obtaining a parameter for converting a position in the first camera coordinate system into a position in a position control coordinate system for controlling a position of the mobile body in a measurement range and a parameter for converting a position in the second camera coordinate system into a position in the position control coordinate system on a basis of a parameter for converting a position in the first camera coordinate system into a position in a mobile body coordinate system based on a position of the mobile body and a parameter for converting a position in the second camera coordinate system into a position in the mobile body coordinate system.

4. The information processing device according to claim 3, wherein the control unit
registers, in the mobile body, information indicating a position of a measurement point planned in advance for acquiring data used for the calibration processing.

5. The information processing device according to claim 2, wherein the control unit
executes accuracy verification processing of verifying accuracy of the calibration processing.

6. The information processing device according to claim 5, wherein the control unit
registers, in the mobile body, information indicating a position of a measurement point planned in advance for acquiring data used for the accuracy verification processing.

7. The information processing device according to claim 6, wherein the control unit
uploads a report indicating a result of the accuracy verification processing to an external device.

8. The information processing device according to claim 1, wherein the mobile body is an unmanned aircraft.

9. The information processing device according to claim 3, wherein the position control coordinate system is a local horizontal coordinate system.

10. An information processing method comprising executing calibration processing of a plurality of cameras by using an image for calibration processing obtained by photographing a mobile body whose movable range is not limited with the plurality of cameras while moving the mobile body as a jig for the calibration processing.
